(19) United States
(12) Patent Application Publication
(10) Pub. No.: US 2006/0109578 A1
(43) Pub. Date: May 25, 2006

(54) Systems and methods for using microjog calibration to detect damaged heads

(75) Inventor: Fernando A. Zayas, Loveland, CO (US)

Correspondence Address: FLIESLER MEYER, LLP, FOUR EMBARCADERO CENTER, SUITE 400, SAN FRANCISCO, CA, 94111, US

(73) Assignee: Matsushita Electric Industrial Co., Ltd., Osaka (JP)

(21) Appl. No.: 10/993,311

(22) Filed: Nov. 19, 2004

(51) Int. Cl. G11B 27/36

(52) U.S. Cl. 360/31

(57) ABSTRACT

A microjog test in a storage device measures a read/write offset indicating a deviation between a positioning of a read/write head during a write operation to a location and a positioning of the read/write head when a peak signal amplitude is measured for data read from the location. By monitoring changes to the read/write offset over time, a testing system can identify read/write heads that are prone to failure.

### FIELD OF THE INVENTION

The present invention relates generally to the testing of data storage devices and particularly to systems methods and computer readable media for detecting storage devices prone to failure.

### BACKGROUND OF THE INVENTION

Over the past ten years, the mass production of data storage devices has become both increasingly large in scale and increasingly competitive. The combination of aggressive computer upgrade schedules, increased storage demands driven by media applications, and the opening of foreign markets to computer sales has driven up the size and scale of storage device production. However, at the same time, increased competition has driven down the cost of computer components such as storage devices. This combination of increased scale and cost-reduction pressures increased the importance of production efficiency.

One of the problems that has hindered efforts to properly quality-test storage devices is the fact that head damage and the associated catastrophic failure is often not detectable beforehand. Hard drives which are being tested or currently in use often fail without warning. What is needed is a process for detecting indicators of head failure.

### BRIEF DESCRIPTION OF THE DRAWINGS

FIG. 1 is a block diagram illustrating a testing apparatus.

FIG. 2 is a block diagram illustrating one embodiment of a computer that acts as a testing system.

FIG. 3 is a block diagram illustrating a more detailed view of a hard drive.

FIG. 4 is a block diagram illustrating a more detailed view of the actuator assembly of the hard drive.

FIG. 5 is a block diagram illustrating a more detailed view of a read/write head.

FIG. 6 is a graph illustrating a relationship between a difference in read/write position and a measured signal produced by a read operation.

FIG. 7 is a flow chart illustrating a process for detecting that a hard drive is prone to failure in accordance with one embodiment of the present invention.

### DETAILED DESCRIPTION

Embodiments of the present invention relate to systems, methods, and computer readable media for testing storage devices such as hard drives. A hard drive undergoing testing is connected to a testing apparatus which sends testing instructions to and receives feedback from the hard drive. Alternately, the hard drive may be associated with a computer system. The hard drive includes at least one read/write head for reading and writing data.

A microjog test measures a read/write offset indicating a deviation between a positioning of a read/write head during a write operation to a location and a positioning of the read/write head when a peak signal amplitude is measured for data read from the location. By measuring changes to the read/write offset over time, a testing system can identify read/write heads that are prone to failure. A changed read/write offset over a relatively short period of time indicates that either a read element or write element is damaged and prone to failure.

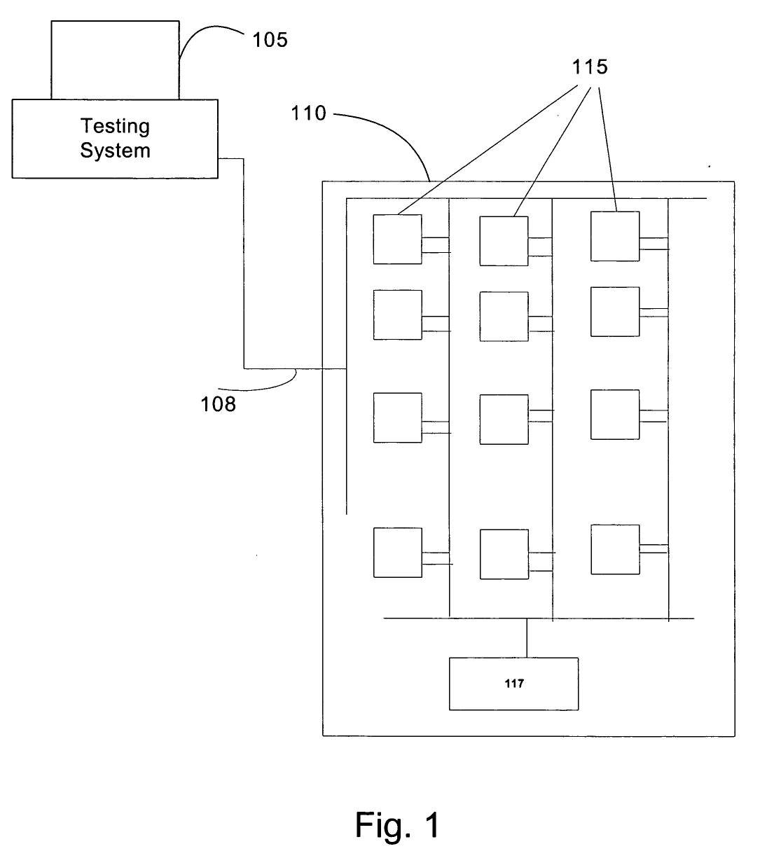

FIG. 1 is a block diagram illustrating an overview of an exemplary system for testing hard drives. The system includes a testing system 105. The testing system 105 may be a conventional computer or a computer configured specially for the purposes of storage device testing. The testing system 105 is configured to transmit testing instructions to an array 110 of hard drives 115 through an interface and to receive feedback from the tested hard drives 115. The hard drives are powered through a power supply 117 connected to the array. Each hard drive has at least two connections, one for data transfer and one for power.

The hard drive array 110 includes multiple hard drives 115 that are connected to the array through one or more serial ports 108, Integrated Drive Electronics (IDE) ports, an infrared wireless connection (e.g. IRDA) or some manner of proprietary connection. In the present embodiment, the hard drives 115 are new drives that have been designated for post-production assembly testing. In an alternate embodiment, the hard drives are drives that have been returned for additional diagnostics. The hard drives 115 perform a series of diagnostic tests that are received from the testing system 105 or stored internally in the hard drives 115. The test system 105 gathers output from the hard drives 115 through the serial ports 108.

In some embodiments, the testing system 105 is not connected to an array, but is a user system (e.g. computer in public or private use) which is performing diagnostics on its own internal storage device or a single external hard drive.

In additional embodiments, the hard drives are connected to the array 110 initially and instructions are downloaded from the test system 105 to the hard drives 115 through the serial ports 118. The test system 105 is then disconnected and the hard drives 115 run the tests, which in one embodiment take 20-30 hours. A system such as the test system 105 can then be reconnected to the array 110, which receives the test results from the hard drives 115. The test results are used to sort the hard drives, with the better performing drives being passed forward to the next manufacturing stage and the weaker performing drives being returned for further testing or rework.

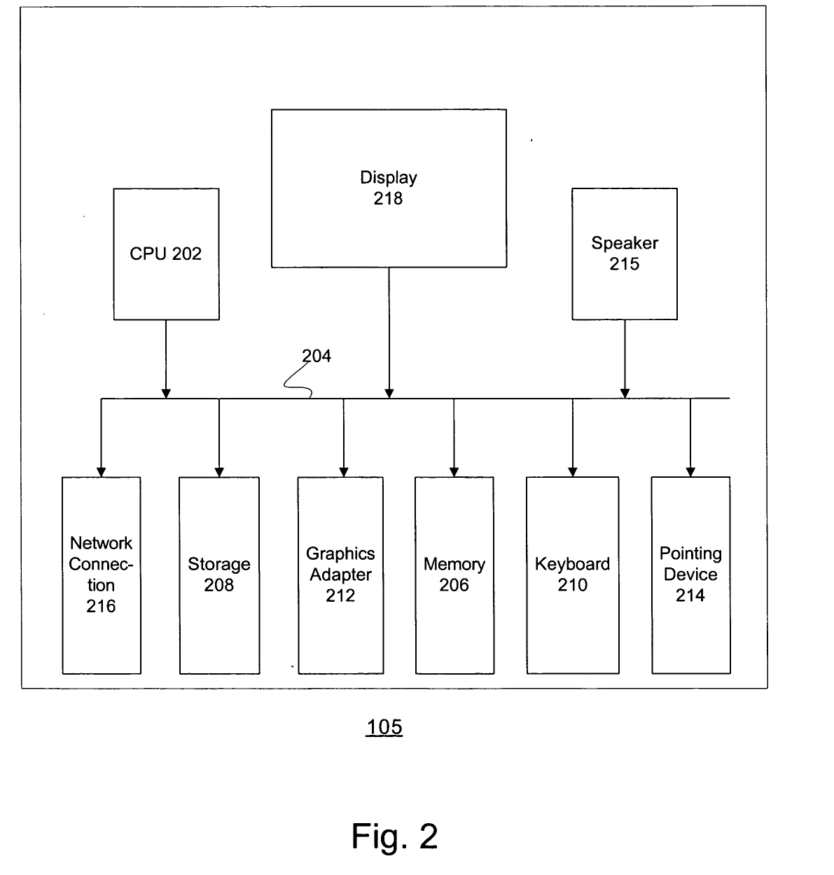

FIG. 2 is a block diagram illustrating a computer that acts as a testing system 105. The system includes a processor 202. There may be more than one processor 202. Coupled to a bus 204 of the processor 202 are a memory 206, a hard drive 208, a keyboard 210, a graphics adapter 212, a pointing device 214, a speaker 215, and a network adapter 216. A display 218 is coupled to the graphics adapter 212.

The processor 202 may be any specific or general-purpose processor such as an INTEL x86 or POWERPC-compatible central processing unit (CPU). The hard drive 208 may be any device capable of holding large amounts of data, such as a hard drive, compact disk read-only memory (CD-ROM), DVD, or some other form of fixed or removable storage device. The test system can also be a portable device such as a laptop or Personal Data Assistant (PDA).

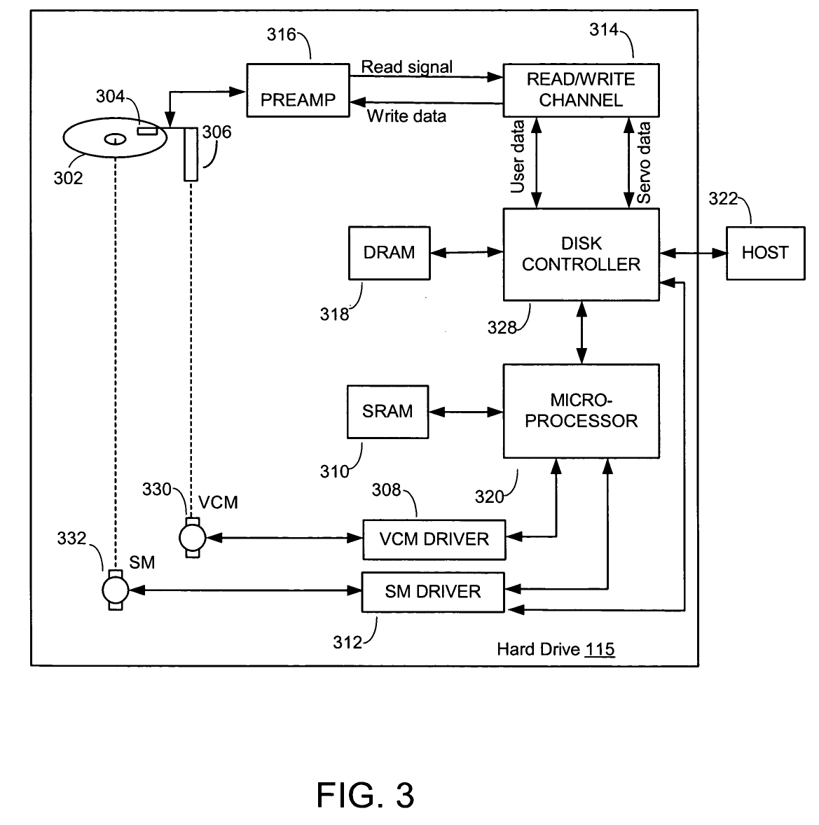

FIG. 3 shows a more detailed view of a storage device 115, which includes at least one rotatable storage medium 302 (i.e., disk) capable of storing information on at least one of its surfaces. In a magnetic disk drive as described below, the storage medium 302 is a magnetic disk. The numbers of disks and surfaces may vary from disk drive to disk drive. A closed loop servo system, including an actuator assembly 306, can be used to position a head 304 over selected tracks of the disk 302 for reading or writing, or to move the head 304 to a selected track during a seek operation. In one embodiment, the head 304 is a magnetic transducer adapted to read data from and write data to the disk 302. In another embodiment, the head 304 includes separate read and write elements. For example, the separate read element can be a magnetoresistive head, also known as an MR head. It will be understood that various head configurations may be used with embodiments of the present invention.

A servo system can include a voice coil motor driver 308 to drive a voice coil motor (VCM) 330 for rotation of the actuator assembly 306, a spindle motor driver 312 to drive a spindle motor 332 for rotation of the disk 302, a microprocessor 320 to control the VCM driver 308 and the spindle motor driver 312, and a disk controller 328 to accept information from a host 322 and to control many disk functions. The host 322 can be any device, apparatus, or system capable of utilizing the storage device 115, such as a personal computer, cellular telephone, or Web server. In one embodiment, the host 322 is the test system 105. The disk controller 328 can include an interface controller in some embodiments for communicating with the host 322, and in other embodiments a separate interface controller can be used. Servo fields on the disk 302 are used for servo control to keep the head 304 on track and to assist with identifying proper locations on the disk 302 where data is written to or read from. When reading servo fields, the head 304 acts as a sensor that detects position information to provide feedback for proper positioning of the head 304 and for determination of the rotational position of the disk 302 via wedge numbers or other position identifiers.

The microprocessor 320 can also include a servo system controller, which can exist as circuitry within the drive or as an algorithm resident in the microprocessor 320, or as a combination thereof. In other embodiments, an independent servo controller can be used. Additionally, the microprocessor 320 may include some amount of memory such as SRAM, or an external memory such as SRAM 310 can be coupled with the microprocessor 320. The disk controller 328 can also provide user data to a read/write channel 314, which can send signals to a preamp 316 to be written to the disk 302, and can send servo signals to the microprocessor 320. The disk controller 328 can also include a memory controller to interface with memory 318. Memory 318 can be DRAM, which in some embodiments, can be used as a buffer memory. In alternate embodiments, it is possible for the buffer memory to be implemented in the SRAM 310.

Although shown as separate components, the VCM driver 308 and spindle motor driver 312 can be combined into a single “power controller.” It is also possible to include the spindle control circuitry in that chip. The microprocessor 320 is shown as a single unit directly communicating with the VCM driver 308, although a separate VCM controller processor (not shown) may be used in conjunction with processor 320 to control the VCM driver 308. Further, the processor 320 can directly control the spindle motor driver 312, as shown. Alternatively, a separate spindle motor controller processor (not shown) can be used in conjunction with microprocessor 320.

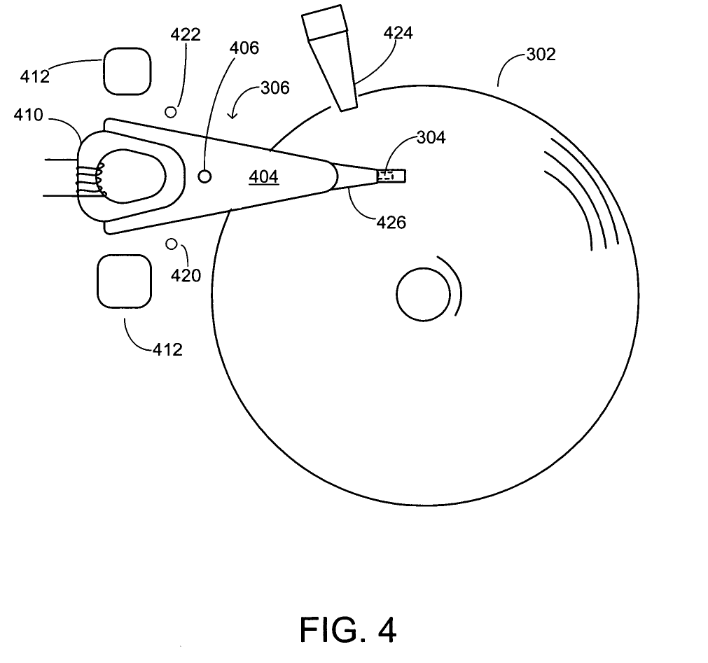

FIG. 4 shows some additional details of the actuator assembly 306. The actuator assembly 306 includes an actuator arm 404 that is positioned proximate the disk 302, and pivots about a pivot point 406 (e.g., which may be an actuator shaft). Attached to the actuator arm 404 is the read/write head 304, which can include one or more transducers for reading data from and writing data to a magnetic medium, an optical head for exchanging data with an optical medium, or another suitable read/write device. Also, attached to the actuator arm 404 is an actuator coil 410, which is also known as a voice coil or a voice actuator coil.

The voice coil 410 moves relative to one or more magnets 412 (only partially shown) when current flows through the voice coil 410. The magnets 412 and the actuator coil 410 are parts of the voice coil motor (VCM) 330, which applies a force to the actuator arm 404 to rotate it about the pivot point 406. The actuator arm 404 includes a flexible suspension member 426 (also known simply as a suspension). At the end of the suspension 426 is a mounted slider (not specifically shown) with the read/write head 304.

The VCM driver 308, under the control of the microprocessor 320 (or a dedicated VCM controller, not shown) guides the actuator arm 404 to position the read/write head 304 over a desired track, and moves the actuator arm 404 up and down a load/unload ramp 424. A latch (not shown) will typically hold the actuator arm 404 when in the parked position. The drive 300 also includes crash stops 420 and 422. Additional components, such as a disk drive housing, bearings, etc. which have not been shown for ease of illustration, can be provided by commercially available components, or components whose construction would be apparent to one of ordinary skill in the art reading this disclosure.

The actuator assembly sweeps an arc between the inner and outer diameters of the disk 302, that combined with the rotation of the disk 302 allows a read/write head 304 to access approximately an entire surface of the disk 302. The head 304 reads and/or writes data to the disks 302, and thus, can be said to be in communication with a disk 302 when reading or writing to the disk 302. Each side of each disk 302 can have an associated head 304, and the heads 304 are collectively arranged within the actuator assembly such that the heads 304 pivot in unison. In alternate embodiments, the heads can pivot independently. The spinning of the disk 302 creates air pressure beneath the slider to form a micro-gap of typically less than one micro-inch between the disk 302 and the head 304.

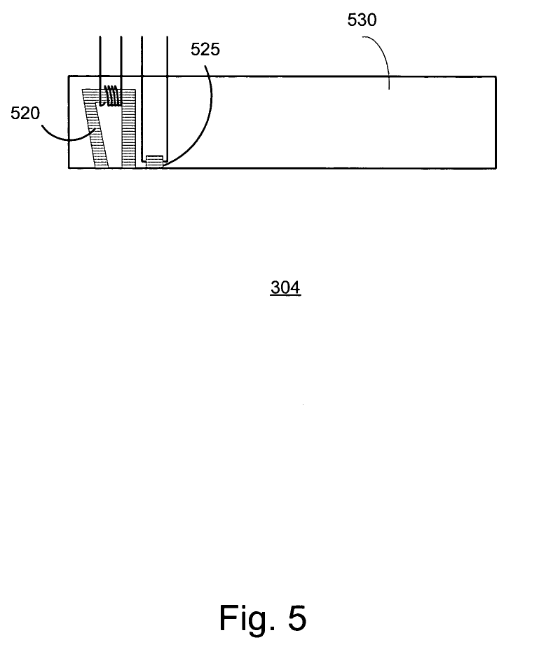

FIG. 5 is a block diagram illustrating a more detailed view of a read/write head 304. The read/write head 304 includes a write element 520 and a read element 525. The write element 520 can be, for example, an inductor coil deposited on a silicon substrate slider 530 that is used to write data on the disk 302 in the form of magnetic transitions. The read element 525 can be, for example, a magneto-resistive (MR) element that is used to detect the data transitions written on the disk 302 by the write element 520.

Although the write element 520 and read element 525 are typically deposited on the same slider in close proximity, they are still separated by a small distance on the read/write head 304. Thus, when reading a location, the hard drive must move the read/write head 304 to a slightly different position on the disk 302 as compared to when writing data from the same location. This effect increases as the read/write head moves across a stroke and the skew angle between the head and the track increases. In order to determine this read/write offset, the hard drive performs a microjog test. The microjog test involves writing data and then shifting the read/write head until a peak amplitude for the written data, or other indicator of a preferred location for reading the data, is detected by the read element 525. In some embodiments, an area is erased using direct current before the test is performed.

In one embodiment, the hard drive stores the read/write offset for future use. A predicted offset for each position on the hard drive is determined according to a series of measured read/write offsets. In some embodiments, a curve fit is applied to a series of measured offsets in order to determine a predicted read/write offset for each location on the storage medium 302. When the hard drive 115 attempts to read data from a selected location, it applies the predicted read/write offset to the write position when moving the read/write head to read the corresponding data.

In one embodiment, the hard drive performs the microjog test as part of a manufacturing and testing process and the read/write offset is set before the product is released from a testing facility. This process can entail a first testing performed at the beginning of a testing process and a second testing during a later test process. In an alternate embodiment, the microjog test is performed periodically in user systems to detect failure prone read/write heads.

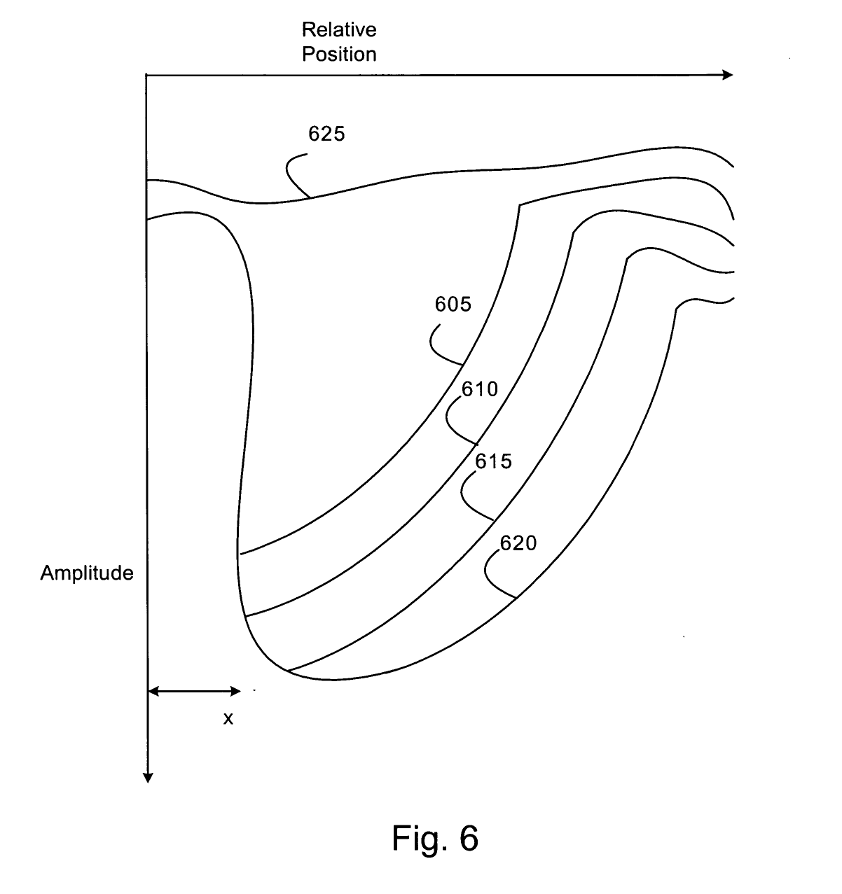

FIG. 6 is a graph illustrating a relationship between a difference in read/write position and a measured signal produced by a read operation. The x axis indicates a position for the read/write head 304 when reading data relative to the position of the read/write head when the data was written. The y axis indicates an inverse amplitude of a measured read signal for each position. The first curve 605 indicates a typical read operation with a peak amplitude at a difference of “x”. For this curve, “x” would represent the read/write offset or the difference value at which a peak signal is measured.

In a properly functioning read/write head, the read/write offset for a particular location would remain constant or vary only slightly. Curves 610, 615, and 620 represent successive readings in which the read/write offset has changed. Additionally, for each of these curves the amplitude of the peak voltage at the read/write offset has been increased in magnitude. The changed read/write offset for each of these curves indicates that either a read element or a write element is beginning to fail, preceding a full failure. Curve 625 illustrates a voltage reading for a read/write head 304 that has suffered a catastrophic failure and is unable to read data from the disk 302.

While in the present embodiment, the read/write offset is determined by measuring a peak amplitude, in an alternate embodiment it can be detected through a test that uses error rate or quality of read signal from internal measurements performed in the read channel while reading. The plots would appear similar to FIG. 6, but the vertical axis would include error rate or read quality metrics.

While FIG. 6 illustrates the peak amplitude and the read/write offset associated with the peak amplitude increasing, in alternate embodiments, either might decrease before a catastrophic failure. The present invention encompasses any situation where microjog behavior changes significantly.

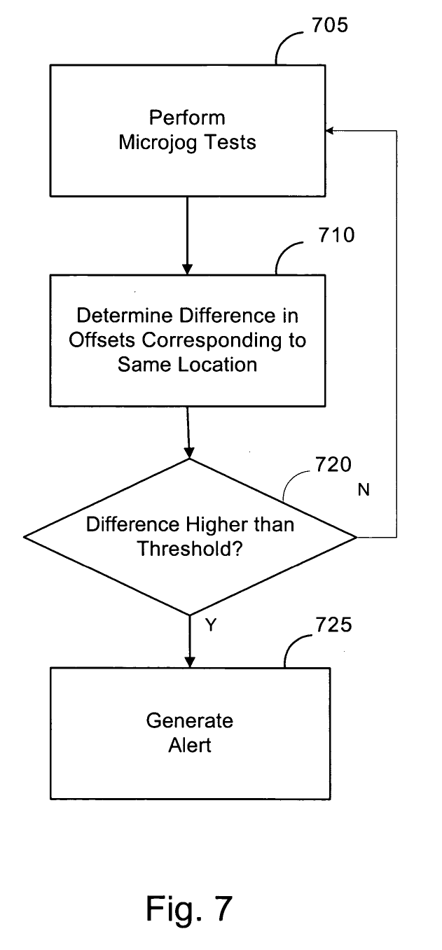

FIG. 7 is a flow chart illustrating a process for detecting that a hard drive is prone to failure in accordance with one embodiment of the present invention. This process may be performed during a pre-sale calibration process or during periodic system self-maintenance. It may be instigated by an external testing system, by a user computer on its own hard drive, or periodically or autonomously by the drive itself.

In step 705 a plurality of microjog tests are performed on the hard drive 115. The microjog test involves writing data to a location using the write element 520 of the read/write head 304 and then shifting the read/write head 304 until a peak amplitude for the written data is detected by the read element 525. For each microjog test a read/write offset is produced, with the read/write offset indicating a difference between a position of the read/write head during a write operation to a location and a position of the read/write head when a peak signal is detected for a read operation on the location.

In step 710 the hard drive 115 checks for differences in the read/write offsets between different microjog tests performed on the same location. In step 720 the hard drive determines whether the change in the read/write offset between the different microjog tests is larger than a predetermined threshold. If the change in the read/write offset is smaller than the threshold, then at a later time, the system tests again as per step 705. If the change in the read/write offset is greater than the threshold then an alert is performed that notifies a user, administrator, or automatic system monitor that the hard drive is at risk for failure because the read or write element is becoming disconnected. If the testing process is performed in a testing facility, the hard drive may be designated for repair. In one embodiment, the alert also includes an automatic data recovery process which retrieves critical data from the hard drive.

Other features, aspects and objects of the invention can be obtained from a review of the figures and the claims. It is to be understood that other embodiments of the invention can be developed and fall within the spirit and scope of the invention and claims.

The foregoing description of preferred embodiments of the present invention has been provided for the purposes of illustration and description. It is not intended to be exhaustive or to limit the invention to the precise forms disclosed. Obviously, many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

In addition to an embodiment consisting of specifically designed integrated circuits or other electronics, the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications.

Included in the programming (software) of the general/specialized computer or microprocessor are software modules for implementing the teachings of the present invention.

What is claimed:

1. A method in a testing facility for determining that a storage device is prone to failure, the method comprising:
determining a read/write offset, the read/write offset indicating a difference between a position of a read/write head during a writing of data and a position of the read/write head during a reading of the data; and
determining whether the storage device is prone to failure according to the read/write offset.

2. The method of claim 1, wherein determining whether the storage device is prone to failure comprises:
determining a difference between the read/write offset and a second read/write offset at a same location; and
determining that the storage device is prone to failure if the difference is larger than a predetermined amount.

3. The method of claim 1, wherein the second read/write offset is determined when the storage device is in a computer system.

4. The method of claim 1, wherein the position of the read/write head during a reading of the data comprises a position where a peak signal amplitude is detected.

5. The method of claim 1, wherein determining the read/write offset comprises receiving a test request from an external testing device to the storage device.

6. The method of claim 1, further comprising generating an alert in response to determining that the storage device is prone to failure.

7. The method of claim 6, wherein generating the alert comprises notifying an administrator that the storage device is prone to failure in response to determining that the storage device is prone to failure.

8. The method of claim 6, further comprising designating the storage device for repair in response to determining that the storage device is prone to failure.

9. The method of claim 6, wherein a change in the read/write offset that is larger than a threshold value indicates that one of the read element and write element is prone to catastrophic failure.

10. A method in a user system for determining that a storage device of the user system is prone to failure, the method comprising:
determining a read/write offset, the read/write offset indicating a difference between a position of a read/write head during a writing of data and a position of the read/write head during a reading of the data; and
determining whether the storage device is prone to failure according to the read/write offset.

11. The method of claim 10, wherein determining whether the storage device is prone to failure comprises:
determining a difference between the read/write offset and a second read/write offset for a same location; and
determining that the device is prone to failure if the difference is larger than a predetermined amount.

12. The method of claim 10, wherein the position of the read/write head during a reading of the data comprises a position where a peak signal amplitude is detected.

13. The method of claim 10, further comprising generating an alert in response to determining that the storage device is prone to failure.

14. The method of claim 13, wherein generating the alert comprises notifying an administrator that the storage device is prone to failure in response to determining that the storage device is prone to failure.

15. The method of claim 13, further comprising designating the storage device for repair in response to determining that the storage device is prone to failure.

16. The method of claim 10, wherein a change in the read/write offset that is larger than a threshold value indicates that a read element is prone to catastrophic failure.

17. The method of claim 10, wherein a change in the read/write offset that is larger than a threshold value indicates that a write element is prone to catastrophic failure.

18. A method in a user system for determining that a storage device is prone to failure, the method comprising:
determining a plurality of read/write offsets for a location, the read/write offsets indicating a difference between a position of a read/write head during a writing of data to the location and a position of the read/write head during a reading of the data to the location;
comparing the plurality of read/write offsets; and
determining that the storage device is prone to failure when a difference among the plurality of read/write offsets is larger than a threshold amount.

19. The method of claim 18, wherein the position of the read/write head during a reading of the data comprises a position where a peak signal amplitude is detected.

20. The method of claim 18, further comprising generating an alert in response to determining that the storage device is prone to failure.

21. The method of claim 20, wherein generating the alert comprises notifying an administrator that the storage device is prone to failure in response to determining that the storage device is prone to failure.

22. The method of claim 20, further comprising designating the storage device for repair in response to determining that the storage device is prone to failure.

23. The method of claim 18, wherein a change in the read/write offset that is larger than a threshold value indicates that a read element is prone to catastrophic failure.

24. The method of claim 18, wherein a change in the read/write offset that is larger than a threshold value indicates that a write element is prone to catastrophic failure.

25. A storage device connected to a testing array, the storage device comprising:
one or more rotatable media for storing data;
a read/write head configured to read data from and write data to the rotatable media; and
a controller configured to:
determine a read/write offset, the read/write offset indicating a difference between a position of the read/write head during a writing of data and a position of the read/write head during a reading of the data; and
determine whether the storage device is prone to failure according to the read/write offset.

26. A storage device in a user system, the storage device comprising:
one or more rotatable media for storing data;
a read/write head configured to read data from and write data to the rotatable media; and
a controller configured to:
determine a read/write offset, the read/write offset indicating a difference between a position of the read/write head during a writing of data and a position of the read/write head during a reading of the data; and
determine whether the storage device is prone to failure according to the read/write offset.

27. A storage device comprising:
a rotatable storage medium for storing data, the rotatable storage medium having a plurality of zones, each zone having a different data density;
an actuator assembly comprising:
a read/write head comprising a read element and a write element; and
an actuator arm configured to move the read/write head to locations on the storage medium for reading and writing data; and
a controller configured to:
determine a plurality of read/write offsets for a location on the storage medium, the read/write offsets indicating a difference between a position of the read/write head when writing data to the location on the storage medium and a preferred position for the read/write head when reading data from the location on the storage medium; and
compare the plurality of read/write offsets; and
determine that the storage device is prone to failure when a difference among the plurality of read/write offsets is larger than a threshold amount.
